(19) United States
(12) Patent Application Publication
(10) Pub. No.: US 2004/0093564 A1
(43) Pub. Date: May 13, 2004

(54) Method and apparatus for visualizing changes in data

(75) Inventors: David Bruce Kumhyr, Austin, TX (US); Robert P. Lowe, Austin, TX (US)

Correspondence Address: DUKE W. YEE, CARSTENS, YEE & CAHOON, L.L.P., P.O. BOX 802334, DALLAS, TX, 75380, US

(73) Assignee: International Business Machines Corporation, Armonk, NY

(21) Appl. No.: 10/290,022

(22) Filed: Nov. 7, 2002

(51) Int. Cl. G06F 15/00

(52) U.S. Cl. 715/526

(57) ABSTRACT

A method and apparatus for visualizing changes in text data, such as in software code or a document, are provided. When two versions of text data are to be compared, each of the versions of text data are loaded into memory, such as a text data buffer. A display of the two versions is then generated with one version of the text data superimposed over the other. That is, the text is compared so that corresponding or matched text is displayed in the same location on the display such that the appearance of corresponding text in the two versions is as if there were a single document displayed. The display is then switched between the first version of the text data and the second version of the text data. The result of such switching is that portions of text that are dissimilar between the versions appear to move due to their dissimilarity. The “movement” of the text is easily discernible to the human eye. In further embodiments, more than two versions of data may be compared and displayed in the above manner such that a morphing affect is achieved as the display switches between versions of the text data. The morphing affect allows a viewer of the text data display to be able to see the historical change of the text data from one version to the other. This morphing can be performed in a forward and backward direction.

### BACKGROUND OF THE INVENTION

1. Technical Field

The present invention is directed to a method and apparatus for visualizing changes to data. In particular, the present invention is directed to an automated method and apparatus for switching from a visual display of one version of a document or code to another such that changes in the versions are represented as movement within the document or code due to a difference in the versions.

2. Description of Related Art

Software development and support is an iterative process. With large projects, multiple persons work on various portions of the software code over time. Since some of the changes to the software code may be relatively small, it is often difficult to discern the changes to the software code from the remaining unchanged code.

In order to better identify such changes in versions of software code, mechanism such as diff and vdiff are used to identify the differences between two versions of code. The diff program provides a listing of the differences between two versions of code. The vdiff program, or visual diff program, statically superimposes the two versions of the code with differences between the two versions highlighted for identification purposes.

Even with the diff and vdiff programs, with large programs having many lines of code, it is often difficult to pinpoint the differences in versions of code with these static mechanisms. That is, the diff program merely provides a listing of the differences and thus, it is difficult to view the differences in the context of the overall code or document. The vdiff program provides a view of the differences in the context of the overall code or document, but the surrounding code or text makes it difficult to locate the differences and the presence of both version superimposed poses additional problems.

Thus, it would be beneficial to have an improved method and apparatus for visualizing changes in data such that the changes are easily identifiable in the context of the overall code or document.

### SUMMARY OF THE INVENTION

The present invention provides an automated method and apparatus for visualizing changes in text data, such as in software code or a document. In a first embodiment of the present invention, when two versions of text data are to be compared, each of the versions of text data are loaded into memory, such as a text data buffer. The present invention then automatically correlates a display of the two versions, one superimposed over the other. That is, the text is compared so that corresponding or matched text is displayed in the same location on the display such that the appearance of corresponding text in the two versions is as if there were a single document displayed. The display is then automatically switched between the first version of the text data and the second version of the text data and vice versa. Such automatic switching may be performed very rapidly such that the result of such switching is that portions of text that are dissimilar between the versions appear to move due to their dissimilarity. The “movement” of the text is easily discernible to the human eye.

In further embodiments, more than two versions of data may be compared and displayed in the above manner such that a morphing affect is achieved as the display switches between versions of the text data. To achieve the morphing affect, the switching may be performed at a less rapid and more gradual rate. The morphing affect allows a viewer of the text data display to be able to see the historical change of the text data from one version to the other. This morphing can be performed in a forward and backward direction, only in a forward direction with the backward direction being performed using rapid switching such as in the previously described embodiment, or the like.

In a further embodiment of the present invention, portions of text data are indexed so that they may be matched with corresponding portions in other versions of the text data. The indexing may take any of a number of forms. For example, a table of references may be stored that reference specific parts of the text data. Alternatively, tags may be inserted into a memory resident copy of the text data (i.e., not the original text data).

When two versions of text data are to be compared to identify differences in the two versions, the indexes are matched for each portion of the text data and for each version of the text data. The text data in matching portions are compared between the two versions. If there is a difference in the text data, the section is marked as having a difference in a comparison results data structure. Then, once all sections have been compared, or as sections are identified as having differences, the sections that are marked as having a difference are displayed in the manner described in the previous embodiments. That is, those sections are displayed in a superimposed manner and the display is automatically switched between the two versions such that differing text appears to move on the display. The user may proceed to the next section of the text data having a difference between versions by inputting a command via an input device.

These and other feature and advantages of the present invention will be described in, or will become apparent to those of ordinary skill in the art in view of, the following detailed description of the preferred embodiments.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary diagram of a computing device in which the present invention may be implemented;

FIG. 2 is an exemplary block diagram of the hardware components of a computing device in which the present invention may be implemented;

FIG. 3 is an exemplary block diagram illustrating the primary operational components of the present invention;

FIGS. 4A and 4B are exemplary diagrams illustrating a first version of text data;

FIG. 5 is an exemplary diagram illustrating a second version of text data; and

FIG. 6 is a flowchart outlining an exemplary operation of the present invention.

### DETAILED DESCRIPTION OF THE PREFERRED EMBODIMENT

With reference now to the figures and in particular with reference to FIG. 1, a pictorial representation of a data processing system in which the present invention may be implemented is depicted in accordance with a preferred embodiment of the present invention. A computer 100 is depicted which includes system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like.

Computer 100 can be implemented using any suitable computer, such as an IBM eServer computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface (GUI) that may be implemented by means of systems software residing in computer readable media in operation within computer 100.

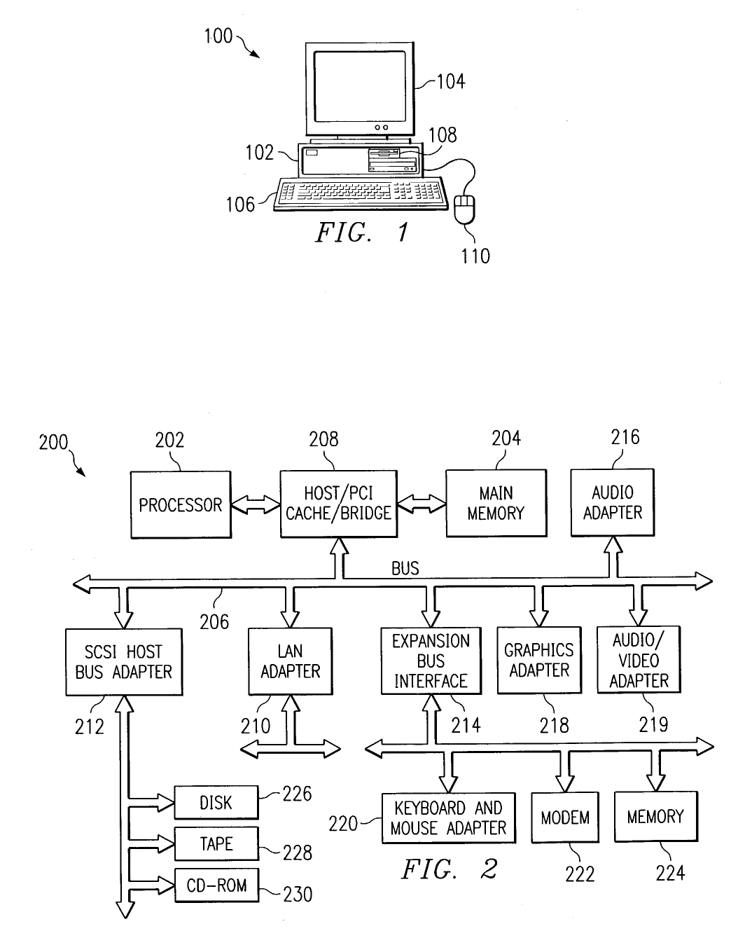

With reference now to FIG. 2, a block diagram of a data processing system is shown in which the present invention may be implemented. Data processing system 200 is an example of a computer, such as computer 100 in FIG. 1, in which code or instructions implementing the processes of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in boards.

In the depicted example, local area network (LAN) adapter 210, small computer system interface SCSI host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors.

An operating system runs on processor 202 and is used to coordinate and provide control of various components within data processing system 200 in FIG. 2. The operating system may be a commercially available operating system such as Windows XP, which is available from Microsoft Corporation. An object oriented programming system such as Java may run in conjunction with the operating system and provides calls to the operating system from Java programs or applications executing on data processing system 200. “Java” is a trademark of Sun Microsystems, Inc. Instructions for the operating system, the object-oriented programming system, and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash read-only memory (ROM), equivalent nonvolatile memory, or optical disk drives and the like, may be used in addition to or in place of the hardware depicted in FIG. 2. Also, the processes of the present invention may be applied to a multiprocessor data processing system.

For example, data processing system 200, if optionally configured as a network computer, may not include SCSI host bus adapter 212, hard disk drive 226, tape drive 228, and CD-ROM 230. In that case, the computer, to be properly called a client computer, includes some type of network communication interface, such as LAN adapter 210, modem 222, or the like. As another example, data processing system 200 may be a stand-alone system configured to be bootable without relying on some type of network communication interface, whether or not data processing system 200 comprises some type of network communication interface. As a further example, data processing system 200 may be a personal digital assistant (PDA), which is configured with ROM and/or flash ROM to provide non-volatile memory for storing operating system files and/or user-generated data.

The depicted example in FIG. 2 and above-described examples are not meant to imply architectural limitations. For example, data processing system 200 also may be a notebook computer or hand held computer in addition to taking the form of a PDA. Data processing system 200 also may be a kiosk or a Web appliance. The processes of the present invention are performed by processor 202 using computer implemented instructions, which may be located in a memory such as, for example, main memory 204, memory 224, or in one or more peripheral devices 226-230.

As discussed previously, the present invention provides an automatic method and apparatus for visualizing changes in text data, such as in software code or a document. With the present invention, when two versions of text data are to be compared, each of the versions of text data are loaded into memory, such as a text data buffer. A display of the two versions is then automatically generated with one version of the text data superimposed over the other. That is, the text is compared so that corresponding or matched text is displayed in the same location on the display such that the appearance of corresponding text in the two versions is as if there were a single document displayed. The display is then automatically switched between the first version of the text data and the second version of the text data, and vice versa, at a rapid rate. The result of such switching is that portions of text that are dissimilar between the versions appear to move due to their dissimilarity. The “movement” of the text is easily discernible to the human eye.

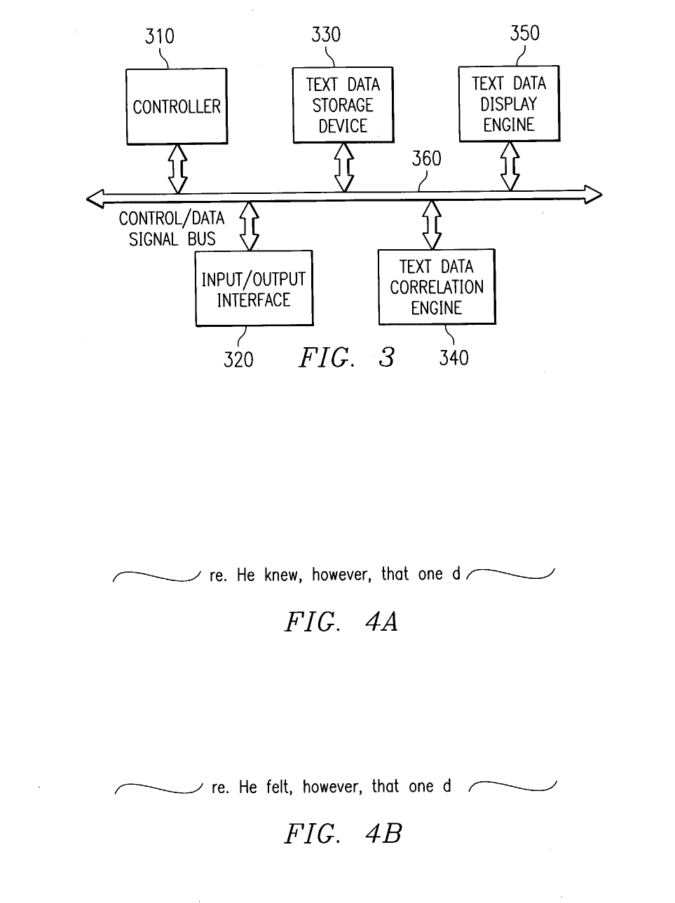

FIG. 3 is an exemplary block diagram illustrating the primary operational components of the present invention. The elements shown in FIG. 3 may be implemented as software, hardware, or any combination of software and hardware. In a preferred embodiment, the elements of FIG. 3 are implemented as software instructions executed by one or more data processing devices.

As shown in FIG. 3, the primary operational components of the present invention include a controller 310, an input/output interface 320, a text data storage device 330, a text data correlation engine 340 and a text data display engine 350. These elements are in communication with one another via the control/data signal bus 360. Although a bus architecture is shown in FIG. 3, the present invention is not limited to such and any architecture that facilitates the communication of information amongst the elements 310-350 may be used without departing from the spirit and scope of the present invention.

The controller 310 controls the overall operation of the present invention and orchestrates the operation of the other elements 320-350. The controller 310 receives a request for identification of differences in versions of text data from an input device via the input/output interface 320. In response, the controller 310 automatically retrieves the versions of the text data identified in the request from a storage device via the input/output interface 320 and stores those versions of the text data in the text data storage device 330, e.g., a text data buffer. The controller 310 then instructs the text data correlation engine 340 to correlate the two or more versions of text data.

In one embodiment of the present invention, the text data correlation engine 340 merely identifies corresponding portions of text in the various versions of the text data based on the actual text therein. Thus, for example, if a paragraph in one version of the text data begins with the phrase “In the beginning . . .” and another version of the text data has a paragraph starting with the same phrase “In the beginning . . .”, this phrase is identified as an anchor point which is used to correlate the two versions of the text data.

Such correlation between the versions of the text data may be identified by performing a text or binary comparison of the two versions of text data. Alternatively, the text data correlation engine 340 may make use of known version control mechanisms to identify differences between the versions of the text data. For example, when changes are made to a first version of text data using a version control mechanism, only the changes are stored in the second version. Similarly, if changes are made to the second version, only those changes are stored in the third version of the text data. In this way, it is a simple matter to identify portions of the text data that are consistent between the versions of the text data and portions of the text data that change over time from version to version.

Multiple anchor points may be identified within portions of the text to aid in correlating the two versions of the text data. For example, each portion of text that corresponds in the two versions may be marked with corresponding anchor points. Thus, a single paragraph may have multiple anchor points if there are portions of text in the paragraph that do not correspond between the two versions of the text data. Thus, the correlation according to one embodiment involves identifying portions of text that are the same in the various versions and marking those portions of text as anchor points for display purposes.

Other factors may be taken into account when determining the correspondence between portions of text in the versions of the text data. For example, page numbers, page breaks, and other formatting features of documents and code may be used to identify corresponding portions of text between versions of the text data. In an alternative embodiment, the text data is indexed such that the indices may be used as anchor points for correlating the two versions of the text data. From the indices it can be determined which portions of text should be similar and thus, any differences between the text in these portions will be displayed as movement in accordance with the present invention. These indices may take many different forms including a table of references to portions of the text data, tags inserted into a memory resident copy of the text data, and the like.

In a further embodiment of the present invention, more than two versions of the text data are correlated using the present invention. In one such embodiment, the correlation between versions of the text data is performed based on a time stamp or version identification associated with each version of the text data. That is, two versions of the text data that are closest to one another in terms of time stamp or version identification are correlated at a time. Thus, for example, if a first version has a time stamp of Dec. 8, 2000 12:06 pm, a second version has a time stamp of Jan. 3, 2001 3:01 am, and a third version has a time stamp of Jan. 21, 2001 5:04 pm, the first and second versions will be correlated and the second and third versions will be correlated using the mechanism of the present invention. It is not necessary to correlate the first and third versions of the text data since the switching will be performed from the first version to the second version to the third version, and vice versa. In this way, as the number of versions increases, it is not necessary to perform correlations between every possible combination of versions.

The text data display engine 350 generates displays of each version of the text data and then outputs commands and data to an output device (not shown) via the output interface 320 to generate the displays of the text data on the output device. The text data display engine 350 automatically sends the commands and data at predetermined intervals without requiring user interaction to facilitate the sending of these commands and data, such that the displays are switched at a rate that provides the illusion of movement in the text being displayed at locations where the text in the various versions of the text data do not correspond.

The text data display engine 350 may send the commands and data signals based on a sequence determined from the time stamps or version identification of the versions of text data stored in the text data storage device. Furthermore, the commands and data sent by the text data display engine 350 includes the anchor points previously identified in such a manner that the displays of the various versions are made consistent based on the positioning of the anchor points. As a result, only the text in the text data that is different between subsequent versions of the text data appears to move as the display automatically switches from one version of the text data to another.

To illustrate how the present invention automatically displays the versions of text data to represent changes as movement, examples of two portions of text are provided. FIG. 4A is an exemplary diagram illustrating a first version of text data and FIG. 4B is an exemplary diagram illustrating a second version of text data. The text in the two versions of text data depicted in FIGS. 4A and 4B are identical with the exception of one word. In the first version of text data shown in FIG. 4A, the phrase “He knew. . .” is used. In the second version of text data shown in FIG. 4B, the word “knew” has been changed to “felt.”

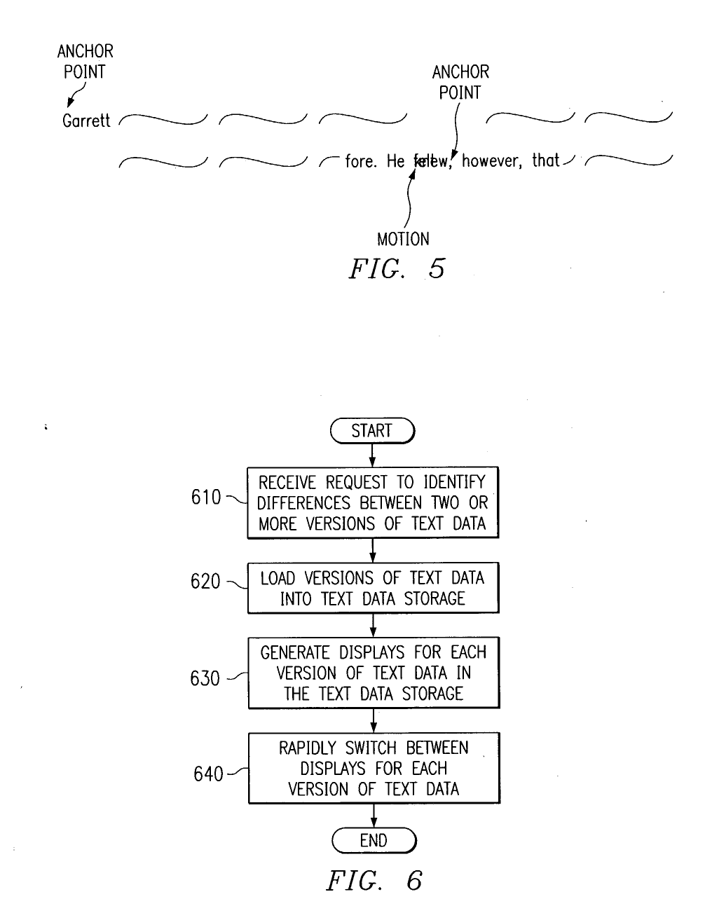

FIG. 5 is an exemplary diagram illustrating a superimposed display of the first version and second version of the text data from FIGS. 4A and 4B. As shown in FIG. 5, there are anchor points at the beginning of sections of the text that correspond between versions of the text data. In the depicted example, the anchor points are at the beginning of the paragraph and at the “,” after the portion of text that is different between versions. The anchor points are not visible in the actual display.

The positions of these anchor points are determined by the comparison of the versions and the identification of corresponding and non-corresponding text data portions. For example, version control mechanism may be used to determine portions of text data that are different and based on this information, anchor points are chosen for portions of text before and after the changed portions.

The portion of text that is different between the versions of the text data is illustrated as having the words “felt” and “knew” superimposed over one another. However, in an actual display, these terms will be displayed sequentially as the display is rapidly and automatically switched between the first version of the text (FIG. 4A) and the second version of the text (FIG. 4B) and vice versa. The result is the illusion of motion in the text as the words change in this location.

FIG. 6 is a flowchart outlining an exemplary operation of the present invention. As shown in FIG. 6, the operation starts with receipt of a request to identify differences between two or more versions of text data (step 610). The versions of text data are then loaded into the text data storage (step 620). Displays of each version of the text data are then generated (step 630). This may involve identifying anchor points in the text data as well as evaluating indices and/or formatting of the text data to identify correlating text between the versions of the text data. Finally, the displays that are generated in step 630 are rapidly and automatically switched in order to provide the illusion of motion in the portions of text that are dissimilar (step 640).

The displays of the text data are output in a similar manner such that text that is the same in each version is in the same place in the display presented on the output device and text that is different appears to switch rapidly providing the appearance of motion. As a result, the human eye is immediately drawn to the point of motion.

In further embodiments of the present invention, rather than displaying the entire text of the text data, only those portions of text in the text data surrounding areas where changes are identified may be displayed. With such an embodiment, the operations for identifying anchor points in the text data may further be used to identify portions of the text where there is a discrepancy, as noted above. The locations of these portions of text in the text data may be stored in a data structure along with portions just before and just after the portions of text that are different. When the displays are generated, only the portions of text just before, just after, and the portion that is different are used to generate the display.

In other embodiments of the present invention, rather than rapidly changing between displays of the versions of the text data, the displays may be automatically morphed in a forward and/or backward direction such that the portions of display of the versions that are different appear to change over time. Morphing is generally known in graphical displays but the application of such morphing to the identification of textual differences in versions of text data has not been known prior to the present invention.

With this alternative embodiment, the operation is virtually the same as discussed in the previous embodiments with the difference being that rather than rapidly switching between versions of the text data, the display morphs from one version to the next and vice versa in a gradual manner. The morphing affect allows a viewer of the text data display to be able to see the historical change of the text data from one version to the other. This morphing can be performed in a forward and backward direction or in only one direction.

Moreover, the morphing from one version of text data to another is especially useful when there are more than two versions of the text data present. As noted above, as one version of the text data morphs to the next in a forward manner, it is possible for the viewer to discern the history of changes made to the text data with each new version of the text data. These changes will be evident as movement or shifting of the text data with corresponding sections of text data remaining stationary in the display.

Thus, the present invention provides mechanisms for identifying changes in text data in a visual manner. More specifically, the present invention provides mechanisms for identifying such changes as motion in text data. The motion provided by the present invention allows changes in text to be viewed quickly while still in the context of the surrounding text. Furthermore, the motion tends to be more discernible by the human eye than highlighting or changes in font color.

While the present invention provides an improvement over known mechanisms for identifying changes using highlight or changes in font color, the present invention may be used in conjunction with such mechanisms to achieve an even greater ability to identify small changes in text data. For example, in addition to the perceived movement achieved through use of the present invention, portions of the different versions of the text data that are different may be displayed in a different color font, a different font, as being highlighted, or the like, to add greater visual emphasis. Thus, in addition to the movement of the text data in locations of the display where text data is different between versions, these other identification mechanisms may also be used in conjunction with the movement to provide greater conspicuousy of the portions of text data that are different between versions.

In a further embodiment of the present invention, as the various versions are displayed and rapidly switched between, or morphed, a version identification may be displayed such that the viewer is informed of the version of text they are currently viewing. Alternatively, versions may be made apparent to the viewer through a predetermined series of colors of font. For example, a first version is displayed in a black font, second version in red, third version in green, fourth version in blue, etc. Other mechanisms for identifying the version currently being displayed may be used without departing from the spirit and scope of the present invention.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for automatically identifying differences between two portions of textual data, comprising:
displaying a first version of the textual data as a first display;
displaying a second version of the textual data as a second display; and
automatically switching between the first display and the second display at a determined rate such that any differences between the first version of the textual data and the second version of the textual data are perceived as motion within a single display of the textual data by a human observer.

2. The method of claim 1, wherein the textual data is software code.

3. The method of claim 1, further comprising:
comparing the first version of the textual data to the second version of the textual data to identify portions of text data that are different between the first version and the second version; and
correlating the display of the first version of the textual data and the display of the second version of the textual data based on the identification of portions of text data that are different between the first version and the second version.

4. The method of claim 1, wherein automatically switching between the first display and the second display includes morphing from the first display to the second display.

5. The method of claim 1, wherein automatically switching between the first display and the second display includes repeatedly and sequentially superimposing the second display over the first display and the first display over the second display, wherein the first display and the second display are correlated based on corresponding anchor points defined in each of the first display and the second display.

6. The method of claim 1, wherein automatically switching between the first display and the second display includes:
identifying corresponding anchor points in the first version of textual data and the second version of textual data; and
correlating the first display with the second display based on the identified corresponding anchor points.

7. The method of claim 6, wherein the corresponding anchor points are identified based on differences between the first version of textual data and the second version of textual data.

8. The method of claim 7, wherein the anchor points are further identified based on formatting of the first version of textual data and formatting of the second version of textual data.

9. The method of claim 1, wherein the first version of textual data and the second version of textual data are selected from a set of two or more versions of the textual data based on time stamps of the two or more versions of textual data.

10. The method of claim 9, wherein the first version of textual data and the second version of textual data are selected based on the time stamp for the second version of textual data being closest to the time stamp of the first version of textual data than any other version of the textual data in the two or more versions of the textual data.

11. A computer program product in a computer readable medium for identifying differences between two portions of textual data, comprising:
first instructions for displaying a first version of the textual data as a first display;
second instructions for displaying a second version of the textual data as a second display; and
third instructions for automatically switching between the first display and the second display at a determined rate such that any differences between the first version of the textual data and the second version of the textual data are perceived as motion within a single display of the textual data by a human observer.

12. The computer program product of claim 11, wherein the textual data is software code.

13. The computer program product of claim 11, further comprising:
fourth instructions for comparing the first version of the textual data to the second version of the textual data to identify portions of text data that are different between the first version and the second version; and
fifth instructions for correlating the display of the first version of the textual data and the display of the second version of the textual data based on the identification of portions of text data that are different between the first version and the second version.

14. The computer program product of claim 11, wherein the third instructions for automatically switching between the first display and the second display include instructions for morphing from the first display to the second display.

15. The computer program product of claim 11, wherein the third instructions for automatically switching between the first display and the second display include instructions for repeatedly and sequentially superimposing the second display over the first display and the first display over the second display, wherein the first display and the second display are correlated based on corresponding anchor points defined in each of the first display and the second display.

16. The computer program product of claim 11, wherein the third instructions for automatically switching between the first display and the second display include:
instructions for identifying corresponding anchor points in the first version of textual data and the second version of textual data; and
instructions for correlating the first display with the second display based on the identified corresponding anchor points.

17. The computer program product of claim 16, wherein the corresponding anchor points are identified based on differences between the first version of textual data and the second version of textual data.

18. The computer program product of claim 17, wherein the anchor points are further identified based on formatting of the first version of textual data and formatting of the second version of textual data.

19. The computer program product of claim 11, wherein the first version of textual data and the second version of textual data are selected from a set of two or more versions of the textual data based on time stamps of the two or more versions of textual data.

20. The computer program product of claim 19, wherein the first version of textual data and the second version of textual data are selected based on the time stamp for the second version of textual data being closest to the time stamp of the first version of textual data than any other version of the textual data in the two or more versions of the textual data.

21. An apparatus for identifying differences between two portions of textual data, comprising:
means for displaying a first version of the textual data as a first display;
means for displaying a second version of the textual data as a second display; and
means for automatically switching between the first display and the second display at a determined rate such that any differences between the first version of the textual data and the second version of the textual data are perceived as motion within a single display of the textual data by a human observer.

22. The method of claim 1, wherein portions of the textual data that are different between the first version of the textual data and the second version of the textual data are displayed in a different manner from portions of the textual data that are the same in the first version of the textual data and the second version of the textual data.

23. The method of claim 1, wherein an identification of the first display includes an identification of the first version of the textual data and the second display includes an identification of the second version of the textual data.
